(19) United States
(12) Patent Application Publication
(10) Pub. No.: US 2026/0054722 A1
(43) Pub. Date: Feb. 26, 2026

(54) ASSISTANCE METHODS WITH BLACK SWAN EVENT HANDLING, DRIVER ASSISTANCE SYSTEM AND VEHICLE

(71) Applicant: Honda Motor Co., Ltd., Tokyo (JP)

(72) Inventors: Tim Puphal, Offenbach (DE); Malte Probst, Offenbach (DE); Raphael Wenzel, Offenbach (DE)

(73) Assignee: Honda Motor Co., Ltd., Tokyo (JP)

(21) Appl. No.: 19/375,196

(22) Filed: Oct. 30, 2025

Related U.S. Application Data
(62) Division of application No. 18/190,143, filed on Mar. 27, 2023.

(51) Int. Cl. B60W 30/095; B60W 10/00; B60W 10/04; B60W 10/18; B60W 10/20; B60W 60/00

(52) U.S. Cl. CPC B60W 30/0956; B60W 10/00; B60W 10/04; B60W 10/18; B60W 10/20; B60W 60/0015; B60W 60/0027; B60W 2554/4046

(57) ABSTRACT

A computer-implemented method for detecting black-swan events for assisting operation of an ego-agent comprises sensing an environment of the ego-agent that includes at least one other agent and predicting behaviors of the at least one other agent based on the sensed environment. The method includes detecting at least one potential black-swan event in the environment of the ego-agent by determining at least one predicted possible behavior of the at least one other agent for which a computed situation probability is smaller than a first threshold, a computed collision probability exceeds a second threshold, and a determined collision severity exceeds a third threshold.

### CROSS-REFERENCE TO RELATED APPLICATION

This application is a divisional application of and claims the priority benefit of a prior application Ser. No. 18/190,143, filed on Mar. 27, 2023, now pending. The entirety of the above-mentioned patent application is hereby incorporated by reference herein and made a part of this specification.

### TECHNICAL FIELD

The invention relates to the field of assistance systems for operating an agent in a dynamic environment. In particular, methods for an automotive driver assistance system with an enhanced capability to perform behavior planning with regard to black swan events are proposed.

### BACKGROUND

Vehicular automation as a technical field relies on technologies such as mechatronics and multi-agent systems to assist an operator of a vehicle (ego-vehicle) in operating the vehicle in a highly dynamic environment including at least one, or even more often, a plurality of other agents. The terms ego-agent and agents in general encompasses vehicles including road vehicles, which today have an increasing number of advanced driving assistance systems available, aircraft with advanced autopilots or unmanned aerial vehicles (UAV, drones), autonomously operating planetary rovers, or watercraft moving on or above the water surface of as well as submersibles. The term agent, in particular when referring to the other agents, may include pedestrians, cyclists or even animals.

An agent using automation for addressing tasks including navigation in the environment, which enable to support but not entirely replace human input by the operator, may be referred to as a semi-autonomous agent. An agent relying solely on automation for operation in the environment is called a robotic or autonomous agent. Similar techniques from automation are present in the field of robotics, in which robotic devices carry out a series of actions automatically. Subsequently, the generic term agent is used, which includes moving devices, e.g. vehicles and robots, which are able to perceive their environment, to plan a behavior deemed adequate to a perceived situation in the environment, and to determine and to execute actions based on the planned behavior autonomously in order to perform tasks.

Characteristic examples of tasks addressed by assistance systems for land vehicles include monitoring of blind spots around the vehicle, assisting in lane changes or assistance at road intersections in a road traffic environment. The capabilities of assistance systems operating vehicles in real time depend on an availability of affordable sensors for perceiving the environment of the vehicle and of the computing power required for processing, both of which improved considerably in recent times. The road traffic environment is a particular application area, in which the increased capabilities of current assistance systems enable to move from assisting in less complex traffic scenarios on roads between cities to coping with congested and highly dynamic urban traffic scenarios.

The design of assistance systems has to address the handling of safety issues and avoiding potential collisions with other agents in the shared environment of the ego-agent and the other agents. An aspect of the planning of future actions in the assistance system is the management of risks associated with the actions of the ego-agent and ensuring compliance with safety margins. Current assistance systems may perform planning of future actions of the ego-agent using risk maps that apply risk models. The assistance system may apply analytical risk models to the domains of predicting a future evolvement of a perceived scenario in the environment, of planning of a potential action or a sequence of actions to be performed by the ego-agent, and of warning an assisted operator or the ego-agent of a perceived risk. Applying analytical risk models in the assistance system may enable to perform autonomously a determined action by the ego-agent. Driving risk models predict movement of vehicles on trajectories along paths and may include risk types, e.g. collisions with other agents in the environment, collisions with static objects, risk resulting from sharp curves or regulatory risk. Risk includes the probability of an event to occur and the consequences of the event, e.g. the severity of the event. Regarding risk during behavior planning for the ego-agent improves the behavior selection and action selection of the ego-agent.

The specific example of driving risk models in a road traffic scenario may use stochastic risk models for agent-to-agent collisions. The driving risk model may assume agents that move on predicted trajectories on paths in the environment. The predicted trajectories of the agents may include general Gaussian and Poisson distributed uncertainties. The generic risk models may be extended beyond modelling the collision risk to integrate further risks, e.g. curve risk or regulatory risk. For the purpose of behavior planning, the ego-agent may perform a cost evaluation based on the risk model. A particular example is a collision risk and addressing the task of the ego-agent determining with which velocity of the ego-agent to proceed on the path of the ego-vehicle in interaction with one other agent in the environment in order to mitigate the collision risk.

The ego-agent may employ the risk model for performing cooperative planning with multiple trajectories and taking into account the paths of a plurality of other agents. In an urban traffic environment, the other agents may also include pedestrians with a high agility, however at low velocities, when compared with motor vehicles. Predicting the future behavior of the other agents, may have to take different potential future behaviors of each of the other agents into account for determining a future behavior of the ego-agent in time and ensuring compliance with a safe evolvement of the traffic scenario. The predicted potential future behaviors of the other agents will typically concentrate on predicted potential future behaviors, which have a high probability that the other agent will act accordingly (probable events, likely behavior). On the other hand, the assistance system will neglect potential future behaviors with a low probability that the other agent will act accordingly (rare events, unlikely behavior).

Patent application US 2017/0090480 A1 discloses an autonomous vehicle operable to follow a primary trajectory that forms part of a route. The autonomous vehicle calculates a failsafe trajectory in response to a predetermined type of event while moving along the primary trajectory.

Nevertheless, even potential future behaviors with a low probability that the other agent will act accordingly and rare events may represent a high risk to operation of the ego-agent in case occurrence of the event will result in a severe outcome. The severe outcome may result from a collision between the ego-agent and at least one other agent at high velocities of the involved agents. Generally, term “black swan event” describes events with catastrophic results. A black swan event is an unpredictable and rare event with an extreme, paradigm-shifting impact on the environment, the environment including in particular the ego-agent.

Black swan events in present context include unlikely other behaviors, which induce a crash with high severity if they occur.

Generally, the black swan theory refers to unexpected events of large magnitude and consequence and their dominant role in history. Based on the black swan theory and Taleb's criteria:
the black swan event is a surprise to the observer, in present context to the ego-agent, and
the black swan event has a major effect on the ego-agent and on planning of future actions of the ego-agent in case the black swan event occurs.

Generally, after a recorded instance of the black swan event, occurrence of the black swan event is rationalized by hindsight, as if it could have been expected: the relevant data pointing towards the event were available from the environment but unaccounted for in risk assessment. The corresponding assessment is true for the personal perception by individual operators.

### SUMMARY

Thus, the aspect of improving an action-planning algorithm assisting operation of the ego-agent for dynamic scenarios in the environment of the ego-agent is an increasingly important task. In particular, improving an assistance system with respect to avoiding or reducing the severity of collisions introduced by black swan events created by the behavior of other agents in the environment of the ego-vehicle is desirable.

The method according to a first aspect and the method according to a second aspect provide advantageous solutions to the task.

The computer-implemented method for detecting black-swan events in an assistance system for operation of an ego-agent according to the first aspect comprises sensing an environment of the ego-agent that includes at least one other agent. The method proceeds by predicting possible behaviors of the at least one other agent based on the sensed environment, and computing for each predicted possible behavior a situation probability and collision probability of a collision with the ego-agent. The predicted behaviors result in different future situations that might evolve from the currently encountered situation. The method then determines for each predicted possible behavior a severity of the collision with the ego-agent. The method identifies a potential black swan event in the environment of the ego-agent in case a predicted possible behavior of the at least one other agent can be determined for which the computed situation probability is smaller than a first threshold, and the computed collision probability exceeds a second threshold, and the determined collision severity exceeds a third threshold, and generates and outputs a detection signal including the detected at least one black swan event to a behavior planning system or a warning system of the ego-agent.

The situation probability may be a probability of occurrence that the situation or the behavior of the at least one other agent is predicted to occur within a prediction horizon (time horizon) from the current time onwards.

The computer-implemented method for assisting operation of the ego-agent according to the second aspect, comprises sensing an environment of the ego-agent that includes at least one other agent, and predicting behaviors of the at least one other agent based on the sensed environment. The method includes planning, by a first planning module, at least one first behavior of the ego-agent based on the predicted behaviors of the at least one other agent, and generating a control signal for at least one actuator for assisting operation of the ego-agent based on the planned at least one first behavior. The method proceeds with detecting at least one black-swan event in the environment of the ego-agent based on the predicted behaviors of the at least one other agent, and planning, by a second planning module different from the first planning module, a second behavior of the ego-agent based on the predicted behaviors of the at least one other agent and the detected at least one black-swan event in the environment of the ego-agent. The method performs monitoring based on the sensed environment whether a computed situation probability of the detected black-swan event exceeds a detection threshold; and, in case the computed situation probability of the detected at least one black-swan event exceeds the detection threshold, generating the control signal for the at least one actuator for assisting operation of the ego-agent based on the planned second behavior.

The dependent claims define further advantageous embodiments of the invention.

### BRIEF DESCRIPTION OF THE DRAWINGS

The description of embodiments and their advantageous effects refers to the enclosed figures:

FIG. 1 shows a simplified flowchart of a method for detecting black swan events according to an embodiment;

FIG. 2 shows a simplified flowchart of the process for detecting black swan events according to the embodiment in more detail;

FIG. 3 illustrates a first example for the occurrence of black swan events in road traffic scenarios;

FIG. 4 illustrates a further examples for the occurrence of black swan events in road traffic scenarios;

FIG. 5 illustrates an example of a road traffic scene with different behavior options and example output values for situation probability, collision probability and collision severity;

FIG. 6 illustrates the same example of a road traffic scene with different behavior options and their black swan detection outputs;

FIG. 7 illustrates a black swan detection process for the different behavior options in the example of the road traffic scene;

FIG. 8 shows a simplified flowchart of a method for planning with two planning modules integrating black swan events;

FIG. 9 illustrates a method for planning with two planning modules integrating black swan events in detail according to an embodiment;

FIG. 10 illustrates complex exemplary traffic situations including plural agents in an urban environment;

FIG. 11 provides an overview over a vehicle according to an embodiment;

FIG. 12 shows a schematic structural diagram of a driver assistance system according to an embodiment;

FIG. 13 illustrates a simplified processing flow for planning a complex behavior of the ego-agent 1 to cope with a complex situation in the environment; and

FIG. 14 illustrates a risk model evaluation process for planning a behavior for the ego-agent in a behavior planning system.

In the figures, corresponding elements have the same reference signs. The description dispenses with describing same reference signs in different figures wherever deemed possible without adversely affecting comprehensibility for sake of conciseness.

### DETAILED DESCRIPTION

The computer-implemented method according the first aspect and according to the second aspect increase robustness of operation of the autonomously operating ego-agent and are equally applicable for driving assistance systems that support an operator in operating the ego-agent. The method according to the first aspect enables to predict several possible situations for the other agents in the environment of the ego-agent and to identify potential behaviors or intentions of each of the other agents, which have a low situation probability, a high collision probability and collision severity according to a first, a second and a third threshold. The identified behavior of the other agents may lead to black swan events in a further evolvement of the current situation in the environment of the ego-agent. The method according to the second aspect enables to consider the detected black swan events in a short-term behavior planner that runs in parallel to the proactive, long-term behavior planner of the ego-agent that guides normally the future behavior of the ego-agent. In the unlikely event that a black swan event actually occurs in the environment involving the ego-agent, the ego-agent may react earlier to the black swan event by switching to executing a behavior planned by the short-term behavior planner that has the capability to provide planning specifically adapted and optimized to cope with black-swan type of events. Additionally or alternatively, the ego-agent may apply a different planning strategy in the second, short-term oriented planner, e.g. driving with a reduced velocity in particular in case a plurality of black-swan events loom in the current driving situation in the environment. Applying the proposed methods alone or in combination enables to integrate the consideration of black swan events in motion planning. The capabilities for assisting in operating the ego-agent in dense and dynamic environments increases significantly.

Detecting black swan events in the assistance systems offers distinct advantages. Detecting black swan events and distinguishing predicted behaviors of other agents which lead to black swan events from predicted behaviors with both a low situation probability and a low collision probability, although the collision severity is high enables to filter the latter predicted behaviors completely out from further consideration by a planning module. Thus, complexity of the planning process for the assistance system decreases. A required computational power and the cost associated therewith also decrease.

Detecting black swan events and distinguishing predicted behaviors that lead to situations with potential black swan events enables to provide in the planning module a distinct and optimized capability to consider these black swan events differently and independently from the long-term proactive planning process optimized for predicted behaviors with a high situation probability. Situation awareness of the planning process and its capability to react appropriately in a wide range of situations increases.

Detecting black swan events is helpful, as the predicted behaviors that may evolve into situations with black swan events may be handled in a separate planner that runs in parallel and simultaneously to the long-term planner. Thus, a rapid change from long-term behavior planning to short term planning in case the situation probability associated with the black swan event should suddenly increase during operation is possible.

For example, the assistance system may warn a driver of an ego-vehicle representing an ego-agent of another agent, which is connected to a detected black swan event. Alternatively or additionally, the assistance system may increase resources for a prediction module in order to obtain refined predictions on the other agent, which is associated with the detected black swan event. This will improve management of processing resources as well as improving safety of operations of the ego-agent.

Detecting black swan events for assisting in operating the ego-agent is advantageous, as behavior planning as a key component of the assistance system may use alternative different strategies based on the detected black swan events. E.g., considering a road traffic scenario and operation of an ego-vehicle, the alternate strategies may include driving with a lower cruising velocity, thereby avoiding catastrophic results for pedestrians moving onto the road between vehicles parked on the roadside. Another strategy taking detected black swan events in to regard may include changing to and driving on a parallel lane in order to avoid a broken vehicle on a lane, where unexpected (low situation probability) events may loom for the ego-agent and other agents alike.

Considering detected black swan events in the parallel short-term planner is advantageous, as the computation time for behavior planning is smaller as the short-term planner is computationally more efficient than the long-term planner, both due to a shorter planning horizon and due to using less complex risk models for planning. The short-term planner may even be parameterized specifically for optimizing reactive planning and unexpected events. The short-term planner running in parallel to the long-term planner enables to react one time-step earlier to an upcoming black swan event. In a specific implementation of a risk-based planning tool, such as risk maps, for example, this may amount to reacting 0.25 seconds earlier, for example. Additionally, the short-term planner may operate with an increased frequency in order to ensure an early availability of a planned behavior for the ego-agent in reaction to an upcoming black swan event.

Considering black swan events and predicted behaviors of other agents associated with potential black swan events in a separate planner enables to set a detection threshold for the situation probability in order to determine the planning strategy differently: setting the detection threshold low may result in a reaction even when the situation probability is still low. Alternatively, the detection threshold may be set high such that the behavior planning only reacts to a detected black swan event in case the black swan event is occurring with near certainty.

The computer-implemented method for detecting black-swan events according to an embodiment comprises monitoring the computed situation probability of the at least one detected black-swan event, and in case the computed situation probability of the detected black-swan event exceeds the detection threshold, changing a planning strategy for operating the ego-agent in the behavior planning system to a different planning strategy.

According to an embodiment of the computer-implemented method for detecting black-swan events, the step of applying the different planning strategy for operating the ego-agent includes decreasing a preset velocity of the ego-agent.

The computer-implemented method for detecting black-swan events according to an embodiment comprises planning a behavior of the ego-agent in a first behavior planning module, based on the predicted possible behaviors of the at least one other agent and the computed situation probability, the computed collision probability and the determined collision severity for the predicted possible behaviors; assisting operation of the ego-agent based on the planned behavior; and monitoring whether the computed situation probability of the detected potential black-swan event exceeds the detection threshold in a second behavior planning module. In case the computed situation probability of the detected black-swan event exceeds the detection threshold, the method performs switching assisting operation of the ego-agent from the planned behavior of the first planning module assisting operation of the ego-agent to a second predicted behavior determined by the second behavior planning module for mitigating effects of the detected black-swan event.

According to an embodiment of the computer-implemented method for detecting black-swan events, the method comprises filtering out predicted behaviors of the at least one other agent from further consideration in the assistance system that have the computed situation probability smaller a fifth threshold and the computed collision probability below a sixth threshold.

The computer-implemented method for assisting operation of the ego-agent according to one embodiment of the second aspect may include the second planning module running in parallel to the first planning module.

According to an embodiment of the computer-implemented method for assisting operation of the ego-agent, the second planning module uses a second risk model less complex than a first risk model used by the first planning module.

For the second planning module of one embodiment of the computer-implemented method for assisting operation of the ego-agent, a time-to-closest encounter risk model without uncertainty consideration is used.

The first planning module may run a survival analysis risk model including uncertainty consideration.

The computer-implemented method for assisting operation of ego-agent according to an embodiment includes a second planning horizon of the second planning module that is shorter than a first planning horizon of the first planning module, or the second planning horizon of the second planning module extends a fraction of the first planning horizon of the first planning module into the future. As an example, the second planning horizon of the second planning module extends up to 4 seconds and the first planning horizon of the first planning module extends up to 12 seconds into the future.

According to an embodiment of the computer-assisted method for assisting operation of the ego-agent, the method includes determining, by the second planning module, the second planned behavior of the ego-vehicle including at least one of a deceleration and a steering angle change that exceed a corresponding deceleration or steering angle change of the at least one first planned behavior determined by the first planning module.

The computer-implemented method for assisting operation of the ego-agent may include the second planning module using a short-term planning algorithm running at a higher frequency than a long-term planning algorithm used by the first planning module. An algorithm is run at a higher frequency when its repetition rate exceeds the repetition rate of another algorithm. This results in shorter response times when new input to the model needs to be considered.

According to an embodiment of the computer-implemented method for assisting operation of ego-agent, the method comprises assigning additional processing resources to a prediction module for predicting the behaviors of the at least one other agent based on the sensed environment in case the computed situation probability of the detected black-swan event exceeds the detection threshold.

The computer-implemented method for assisting operation of the ego-agent may comprise the second planning module using a second planning strategy different from a first planning strategy used by the first planning module, or the second planning module using a second planning strategy different from the first planning strategy wherein the second planning strategy has a smaller cruising velocity for the ego-agent compared to the first planning strategy.

The computer-implemented method for assisting operation of the ego-agent according to an embodiment represents the second planning module using, for each predicted situation that includes predicted behaviors for many other agents, one other agent with a predicted unlikely behavior and a most likely behavior for all other agents different from the one other agent.

This embodiment achieves in particular that executing the planned behavior provided by the second planner results in avoiding collisions with other agents.

The computer-implemented method for assisting operation of the ego-agent may comprise detecting a plurality of black swan events in the environment of the ego-agent, monitoring based on the sensed environment whether each computed situation probabilities of the detected plural black-swan events exceeds a corresponding detection threshold; and, in case the computed situation probabilities of the detected potential black-swan events exceed the corresponding detection threshold for plural detected black-swan events, switching to a planned second behavior of a black swan event of the plural black swan events, which is predicted to occur closest to a current time.

According to an embodiment of the computer-implemented method for assisting operation of the ego-agent, the method comprises while generating the control signal based on the planned second behavior, monitoring based on the sensed environment whether the computed situation probability of the detected black-swan event falls below a detection threshold, and switching to generating the control signals for the at least one actuator based on the planned at least one first behavior in case the computed situation probability of the detected potential black-swan event falls below the detection threshold.

The computer-implemented method for assisting operation of the ego-agent according to an embodiment comprises operating the ego-agent that includes autonomously operating the ego-agent or assisting a human driver in operating the ego-agent, and the ego-agent includes at least one of a land vehicle, a watercraft, an air vehicle and a space vehicle.

The following discussion of embodiments predominantly refers to a road traffic scenario including vehicles, bicycles and pedestrians as specific examples of the other agents in the environment of an ego-vehicle as a specific example for the ego-agent. It suffices to mention that the road traffic scenario is only one application example, which is of particular commercial interest and useful for illustrating an embodiment of the invention. Application of the methods as defined in the attached claims is by no means restricted to the discussed road traffic scenario.

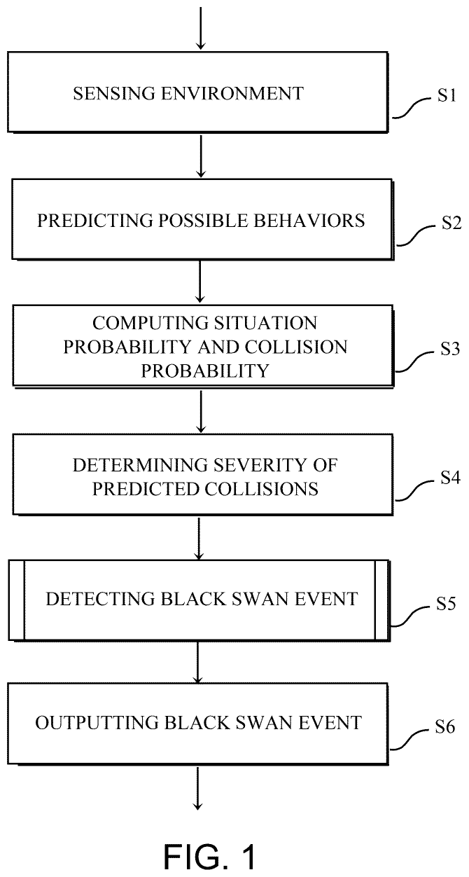

FIG. 1 shows a simplified flowchart of a method for detecting black swan events according to an embodiment.

In step S1, the method is sensing the environment of the ego-agent.

In step S2, the method proceeds with predicting possible behaviors of other agents detected in the environment of the ego-agent based on the sensed sensor signal.

In step S3, the method computes a situation probability based on the predicted behaviors of the other agent and further on planned behaviors of the ego-agent. Each predicted behavior of another agent includes a predicted trajectory of the other agent. Each planned behavior of the ego-agent includes a planned trajectory of the ego-agent.

Furthermore, in step S3 the method determines possible collision events involving the ego-agents and the detected other agents. In particular, the method determines the possible collision events based on the predicted behaviors of the other agent and further on planned behaviors of the ego-agent and computes a collision probability for each determined collision event.

In step S4, the method proceeds with determining a collision severity for each of the predicted potential collisions.

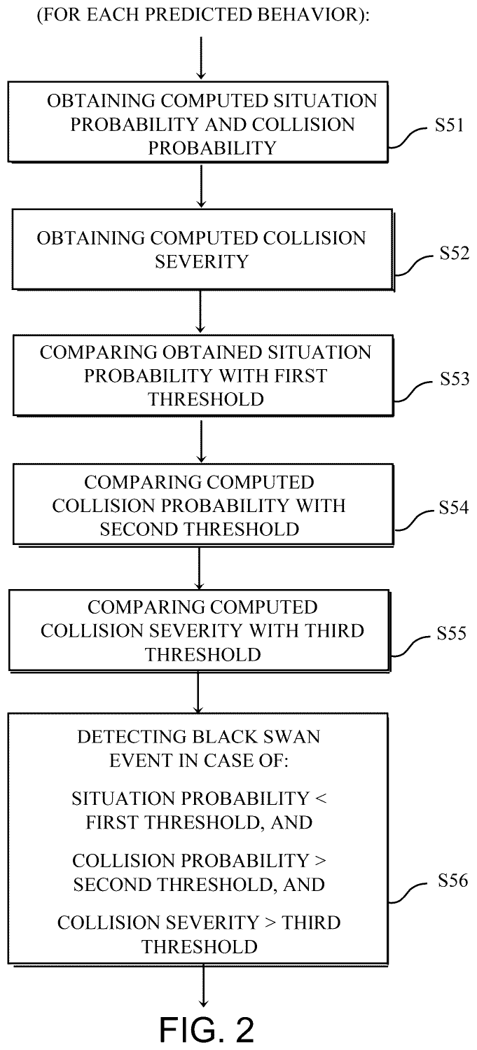

In subsequent step S5, the method proceeds with detecting black swan events. The process of detecting black swan events is discussed in detail with reference to FIG. 2.

The step S5 of detecting black swan events includes determining whether a black swan event exist in the current situation in the environment of the ego-agent, and which potential evolvement of the current scenario is the detected potential black swan event.

In case the method detects in step S5 a black swan event, the method proceeds to step S6 and outputs the detected black swan event, e.g. to a behavior planner of the ego-agent to proceed with appropriate actions based on the detected black swan event in the environment of the ego-agent.

FIG. 2 shows a simplified flowchart of the process for detecting black swan events according to the step S5 of FIG. 1 in more detail.

The process of for detecting black swan events starts in step S51 with obtaining, for each predicted behavior of the other agent and each planned behavior of the ego-agent with obtaining the computed situation probability and the computed collision probability.

In step S52, the method obtains the computed collision severity for each determined collision.

The method may perform the steps S51 and S52 at least partially in parallel or sequentially.

In step S53, the method proceeds with comparing the obtained situation probability for each collision event with a first threshold.

In step S54, the method proceeds with comparing the obtained collision probability with a second threshold.

In step S55, the method proceeds with comparing the obtained collision severity with a third threshold.

The method may perform the steps S53, S54, and S55 at least partially in parallel or sequentially.

In step S56, the process determines whether a black swan event exists in the environment of the ego-agent based on the comparison of the obtained situation probability for each collision event with the first threshold, the comparison of the obtained collision probability with the second threshold and the comparison of the obtained collision severity with a third threshold. In particular, the method detects a black swan event to exist in a collision event, for which:
the situation probability is smaller than the first threshold, and
the collision probability is larger than the second threshold, and
the collision severity exceeds the third threshold.

The process of detecting the black swan event then returns the detected black swan event to step S5 and proceeds with step S6 of FIG. 1.

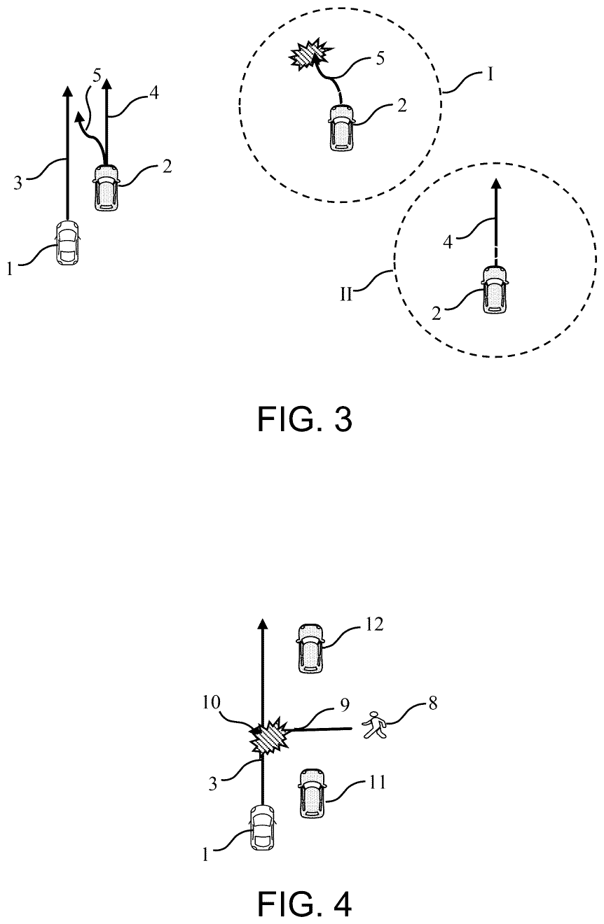

FIG. 3 illustrates a first example for the occurrence of black swan events in a road traffic scenario.

The depicted traffic scenario includes an ego-agent 1, e.g. an ego-vehicle cruising with a first velocity (ego-velocity) along a left lane on a road with two lanes for one driving direction. One other agent 2 (other vehicle) drives in the same driving direction as the ego-vehicle. The other vehicle 2 has a second velocity, and is currently on the right lane of the road and situated towards the front of the ego-vehicle in the driving direction. The first velocity of the ego-vehicle is assumed to exceed the second velocity of the other vehicle.

The assistance system of the ego-agent 1 predicts two possible behaviors for the other agent in the driving scenario of FIG. 3. The first behavior I comprises the other vehicle changing from the right lane to the left lane right in front of the ego-vehicle on a predicted trajectory 5 of the first behavior I of the other vehicle. The second behavior II comprises the other vehicle continuing to drive on the right lane on a predicted trajectory 4 of the second behavior II of the other vehicle.

The first behavior I has a low probability, in particular a lower probability than the second behavior II when considering the scenario of FIG. 3. The other vehicle will most probably be aware of the approaching ego-vehicle on the left lane and maintain its present course on the right lane. The second behavior II includes an expected intention of the other vehicle. The first behavior I denotes an unexpected intention of the other vehicle. A planned trajectory 3 of the ego-vehicle and the predicted trajectory 4 of the other vehicle do not intersect in the planning horizon. Thus, the predicted behavior II of the other vehicle and the planned behavior of the ego-vehicle do not result in a collision event.

The first behavior I of the other vehicle comprises a predicted trajectory 5 that intersects with the planned trajectory 3 of the ego-vehicle on the left lane within the planning horizon of the assistance system. Thus, the predicted first behavior I and the planned behavior of the ego-vehicle combine to a predicted collision event. The predicted collision event is considered to have a low probability of occurrence (situation probability) due to the alleged low probability of the predicted first behavior I of the other vehicle. Nevertheless, the predicted collision event may be alleged to have a high predicted severity of the collision event: both the colliding vehicles drive with a high velocity and the other vehicle will presumably hit the ego-vehicle on its right side, possibly resulting in the ego-vehicle skidding from the road or even running into the oncoming traffic. The predicted collision event resulting from the predicted first behavior of the other vehicle and the planned behavior of the ego-vehicle represents an example for a black swan event with a low probability of occurrence, a high collision probability, and a high collision severity in the traffic scenario of the left portion of FIG. 3.

Generally, the assistance system will be devised in order to plan a safe and proactive behavior considering all possible relevant intentions of the other agents 2 in the environment of the ego-agent 1. If the assistance system would consider all possible intentions the other agents 2 in the environment of the ego-agent 1, independent of their relevance, the assistance system would plan excessively defensive or even come to a full stop. Thus, not all possible intentions of the other agents 2 will be regarded: there exists no acting in the environment that does not involve a level of risk. Turning to the example of the traffic environment: if the other vehicle wants to have an accident in form of a collision with the ego-vehicle, it will be able to do so by performing an unexpected behavior. The presented approach enables to detect such black swan events and to handle specifically detected black swan events in the planning process of the assistance system.

FIG. 4 illustrates a further example for the occurrence of a black swan event in a road traffic scenario.

The road traffic scenario of FIG. 4 shows the ego-agent 1 (ego-vehicle) moving straight on a road section passing two stationary other agents 11, 12 positioned behind each other at the right side of the road. The other agents 11, 12 may be other vehicles parking at the side of the road. A further other agent 8 (pedestrian) is shown on the sidewalk on the side of the parked vehicles that is opposite to the road and moving towards a gap between the first and second parked vehicles. An assistance system of the ego-vehicle may assess a behavior of the pedestrian to pass between the two parked vehicles and to move onto the road as improbable, as under most circumstances the ego-vehicle has the right-of-way in the depicted situation. Thus, the assistance system will predict the behavior of the pedestrian following on a predicted trajectory 9 with a low situation probability. Moreover, the pedestrian may suffer serious harm if appearing between the parked vehicles and proceeding on the predicted trajectory 9 intersecting with the planned trajectory 3 of the ego-vehicle until a collision event 10 occurs involving the ego-vehicle and the pedestrian. If, however, the pedestrian continues to move on the predicted trajectory 9, the collision probability is high as the trajectories do indeed intersect within the planning horizon of the assistance system. If the collision event 10 involving the pedestrian and the ego-vehicle occurs, potential consequences of the collision will also be severe, in particular on the side of the pedestrian, which lacks the protection provided by the car body of the ego-vehicle.

Thus, the collision event 10 shown in FIG. 4 qualifies as a black swan event according to the criteria set by the method according to the first aspect. The method determines in step S56 of FIG. 2 that the situation probability for the unexpected intention of the pedestrian to proceed on the predicted trajectory 9 is small, e.g. below the first threshold. The collision probability for the collision event 10 including the ego-vehicle and the pedestrian is high in case the pedestrian proceeds on the predicted trajectory 9, e.g. collision probability for the collision event 10 exceeds the second threshold. The collision severity for the collision event 10 including the ego-vehicle and the pedestrian is also high in case the pedestrian proceeds on the predicted trajectory 9 and the collision actually occurs, e.g., the collision severity of the collision event 10 exceeds the third threshold.

The assistance system of the ego-agent 1 will, accordingly by applying the steps S1 to S6 of the method detect black swan event in the shown scenario in the environment of the ego-agent 1. The unexpected intention of the pedestrian as the other agent 8 represents such black swan event in FIG. 4. The capability of detecting black swan events for the ego-agent 1 enables to introduce specific measures by the assistance system, e.g. in a planning module of the assistance system to consider the detected black swan events in an adequate manner.

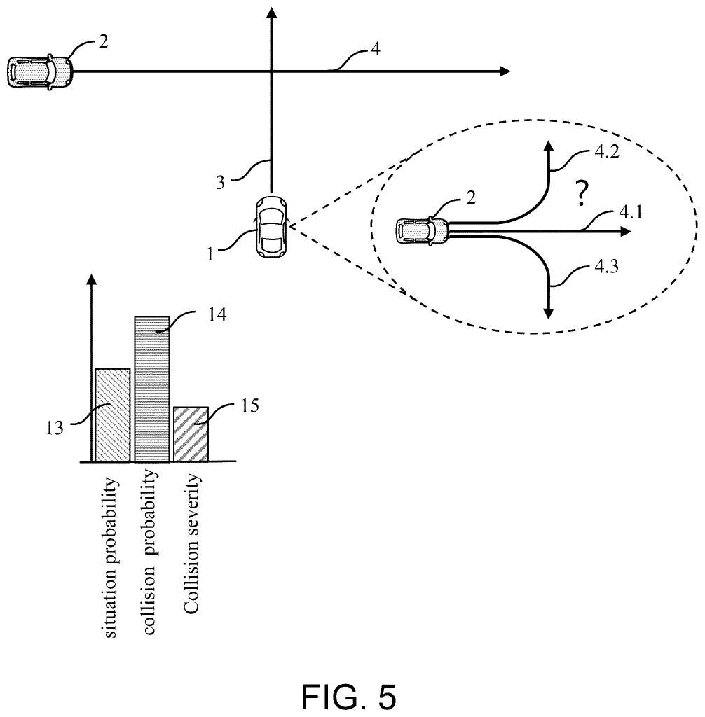

FIG. 5 illustrates a further example of a road traffic scenario with different behavior options for planning a behavior of the ego-agent 1.

The traffic scenario of FIG. 5 includes the ego-agent 1, e.g. an ego-vehicle assisted by an assistance system including an implementation of the method according to FIG. 1, and one other agent 2, e.g. another vehicle, moving on straight movement paths, which intersect at right angles within the planning horizon of the assistance system. The depicted road traffic scenario may illustrate an intersection in a road traffic environment.

The ego-vehicle moves along a planned trajectory 3. The sensors of the ego-vehicle detect the other vehicle 2 moving along a predicted trajectory 4, which intersects the ego-trajectory 3 within the planning horizon. The assistance system of the ego-vehicle determines three potential evolvements of the traffic situation based on the sensed environment including the other vehicle 2. The three potential evolvements, each including a respective predicted behavior of the other vehicle 2. The predicted potential evolvements of the current traffic situation and the respectively predicted trajectories of the other vehicle are indicated in the dashed circle in FIG. 5.

A first predicted behavior of the other vehicle includes the other vehicle continuing to move along a straight towards and beyond an intersecting point of the ego-trajectory 3 and a first predicted trajectory 4.1 of the other vehicle. Thus, the first predicted behavior includes the first predicted trajectory 4.1.

A second predicted behavior of the other vehicle includes the other vehicle turning to its left at the intersecting point of the ego-trajectory 3 and the predicted trajectory 4 of the other vehicle, and subsequently after turning to the left to move straight in the same direction as the ego-trajectory 3. Thus, second predicted behavior includes the second predicted trajectory 4.2.

A third predicted behavior of the other vehicle includes the other vehicle turning to the right before a potential collision point of the other vehicle with the ego-vehicle. The third predicted behavior includes the third predicted trajectory 4.3.

The assistance system evaluates a risk associated with each of the determined predicted behavior alternatives of the other vehicle that including a respective predicted trajectory 4.1, 4.2, and 4.3. Generally, the risk associated with a predicted behavior of the other vehicle and the planned behavior of the ego-vehicle is defined as

$$risk = ( situation probability ) \times ( collision propability ) \times ( collision severity ) ; \qquad ( 1 )$$

The assistance system may determine each of the components situation probability, collision probability, and collision severity of the risk definition in (1) separately during the planning process in order to detect black swan event inherent in the current situation in the environment of the ego-vehicle.

FIG. 5 illustrates example values for the components (variables) situation probability 13, collision probability 14 and collision severity 15 for estimating a risk for a behavior in the example of a road traffic scenario of FIG. 5.

The assistance system of the ego-agent 1 may determine the variable situation probability 13 based on applying a predetermined prediction model on the current scenario and the specific predicted behavior of the other agent 2.

The assistance system of the ego-agent 1 may determine the variable collision probability 14 by performing a survival analysis on the current scenario and the specific predicted behavior of the other agent 2.

The assistance system of the ego-agent 1 may determine the variable collision severity 15 by applying a kinematic crash model on the current scenario and the specific predicted behavior of the other agent 2 under the assumption that the predicted situation and the predicted collision actually occurs.

FIG. 5 illustrates each of the determined variable situation probability 13, collision probability 14 and collision severity 15 with a determined value in the diagram in the lower left portion of FIG. 5. The determined variable values of the situation probability 13, collision probability 14 and collision severity 15 are each considered individually for detecting black swan events in the scenario based on the process steps S51 to S56, and, in particular, in steps S53, S54, and S55 of FIG. 2.

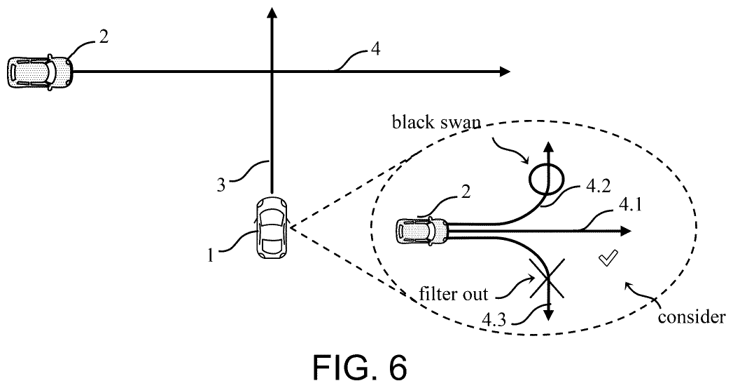

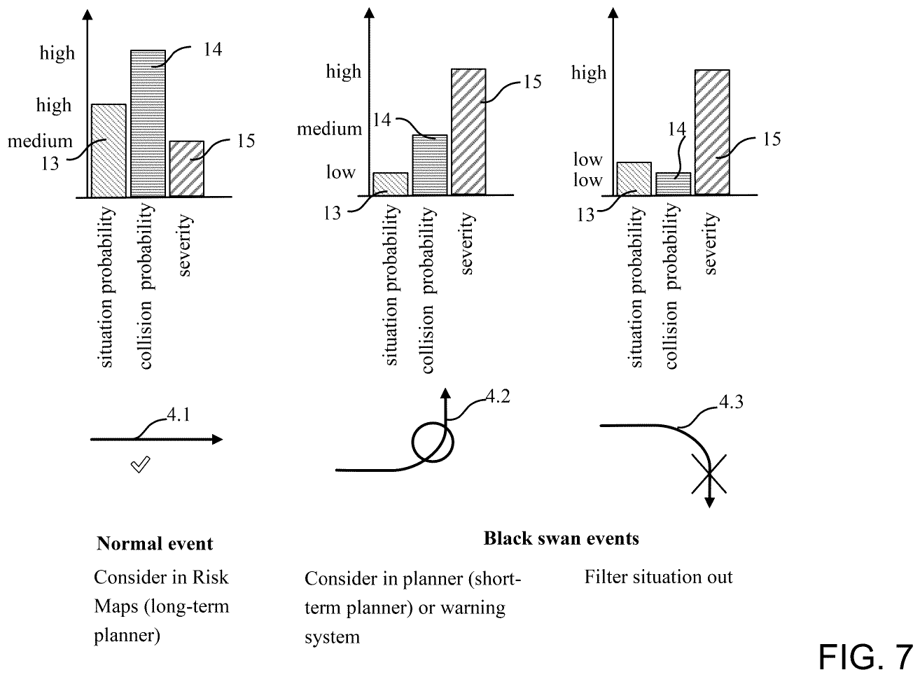

FIG. 6 illustrates the example of the road traffic scenario of FIG. 5 with the different behavior alternatives in more detail with regard to the evaluation of the individual predicted behavior alternatives and a result of the black swan detection for consideration in further planning in the assistance system. FIG. 7 is associated with the road traffic scenario of FIG. 6 and illustrates schematic examples for determined parameter values for the situation probability 13, collision probability 14 and collision severity 15 for the specific road traffic scenario of FIGS. 5 and 6.

FIG. 6 shows the ego-vehicle moving along the planned trajectory 3. The sensors of the ego-vehicle detect the other vehicle 2 moving along the predicted trajectory 4, which intersects the ego-trajectory 3 within the planning horizon. The assistance system of the ego-vehicle determines the three potential evolvements of the traffic situation of FIG. 6. The dashed circle in FIG. 6 includes the three predicted potential evolvements of the current traffic situation and the respectively predicted trajectories of the other vehicle. The first predicted behavior of the other vehicle includes the other vehicle continuing to move along a straight towards and beyond an intersecting point of the ego-trajectory 3 and a first predicted trajectory 4.1 of the other vehicle. The second predicted behavior of the other vehicle includes the other vehicle turning to its left at the intersecting point of the ego-trajectory 3 and the predicted trajectory 4 of the other vehicle, and subsequently moving on the predicted trajectory 4.2 into the same direction as the planned ego-trajectory 3. The third predicted behavior of the other vehicle includes the other vehicle turning to the right at a potential collision point of the other vehicle with the ego-vehicle and then moving in to the opposite direction of the planned ego-trajectory on the predicted trajectory 4.3.

The assistance system evaluates a risk associated with each of the determined predicted behavior alternatives of the other vehicle that including the respective predicted trajectories 4.1, 4.2, and 4.3. In particular, the assistance system determines the variables defining the risk with each of the first behavior, the second behavior, and the third behavior in the road traffic scenario of FIG. 7.

The upper portion of FIG. 7 illustrates schematic example for values for the situation probability 13, collision probability 14 and collision severity 15 for normal events and for black swan events in the example of the road traffic scenario of FIGS. 5 and 6.

The first predicted behavior and the predicted trajectory 4.1 of the first predicted behavior is in the left portion of FIG. 7. The components of the risk evaluation of the first predicted behavior reveal a high value for the situation probability 13, a high value for the collision probability 14, and a low value for the collision severity 15. Based on the value distribution for the risk components in the left upper portion of FIG. 7, the first predicted behavior will not qualify as a black swan event in method step 5 respective the process for detecting black swan events according to steps S51 to S56 of FIG. 2. This is depending on the actual setting of the first, second and third thresholds in steps S53, S54, and S55 of FIG. 2. In particular, the high value for the situation probability 14 exceeding the first threshold and the low value for the collision severity 15 smaller than the third threshold in step S56 will result in determining that the first predicted behavior does not include a black swan event.

Due to a high value for the situation probability 13 for the predicted first behavior, which exceeds the values of the respective situation probabilities 13 of the second behavior and the third behavior, the first behavior is considered to represent a normal event.

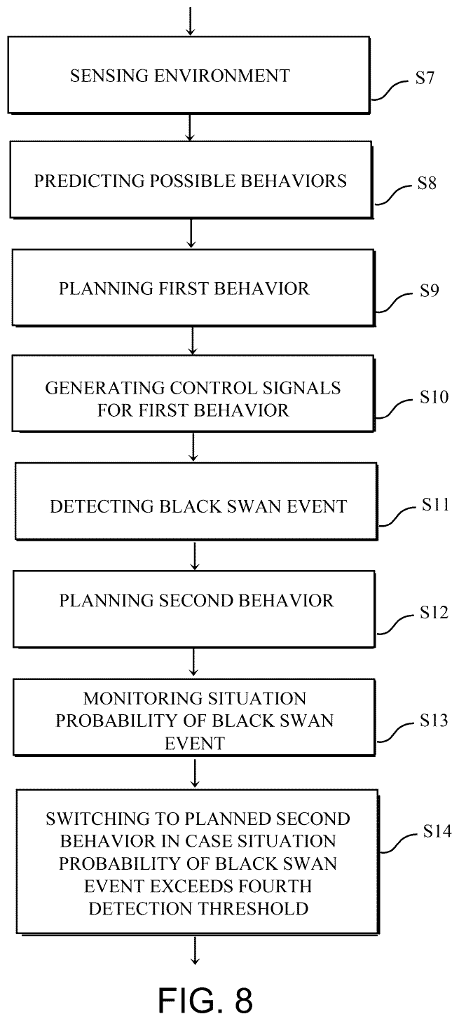

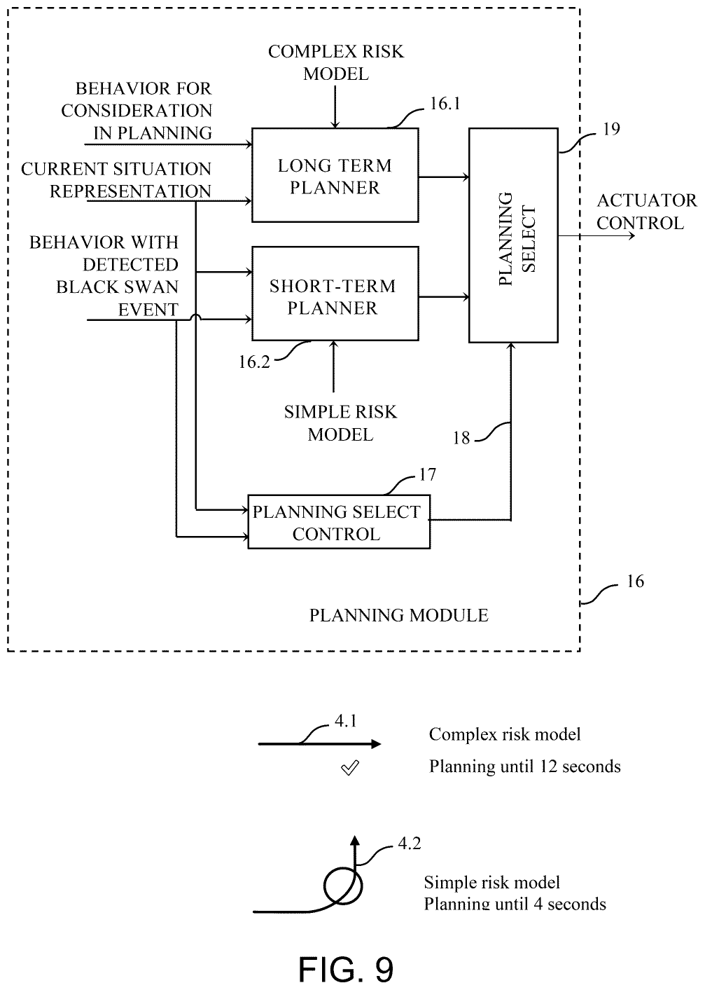

In particular, the first predicted behavior may form the basis in behavior planning for the ego-agent 1 for further consideration in a long-term planner, e.g. based on Risk Maps, as will be discussed with reference to FIGS. 8 and 9 in more detail.

The second predicted behavior and the predicted trajectory 4.2 of the second predicted behavior are in the center portion of FIG. 7. The components of the risk evaluation of the second predicted behavior reveal a low value for the situation probability 13, a medium value for the collision probability 14, and a high value for the collision severity 15. Based on the value distribution for the risk components in the upper center portion of FIG. 7, the second predicted behavior will qualify as a black swan event in method step 5, respective the process for detecting black swan events according to steps S51 to S56 of FIG. 2. This depends on the actual setting of the first, second and third thresholds in steps S53, S54, and S55 of FIG. 2. In particular, in case the medium value for the collision probability 15 exceeds the second threshold in step S54 and the high collision severity exceeding the third threshold in step S55, will result in determining that the second predicted behavior does include a black swan event in step S56 of the process of FIG. 2.

In particular, determining that the second predicted behavior results in a potential black swan event for the ego-agent 1, the assistance system may handle the second predicted behavior in another planning module respectively, e.g., for further consideration in a short term planner, as will be discussed with reference to FIGS. 8 and 9 in more detail.

Alternatively or additionally, the assistance system may consider the second predicted behavior in a dedicated warning system or warning module of the assistance system.

The third predicted behavior and the predicted trajectory 4.3 of the third predicted behavior are in the right portion of FIG. 7. The components of the risk evaluation of the third predicted behavior reveal a low value for the situation probability 13, a low value for the collision probability 14, and a high value for the collision severity 15. Based on the value distribution for the risk components in the upper right portion of FIG. 7, the third predicted behavior may qualify as a black swan event in method step 5, respective the process for detecting black swan events according to steps S51 to S56 of FIG. 2. This depends on the actual setting of the first, second and third thresholds in steps S53, S54, and S55 of FIG. 2. Nevertheless, in case the low value for the collision probability 15 is smaller than the third threshold in step

S55 may most probably result in S56 to disqualify the third predicted behavior in the black swan detection according to FIG. 2, although the high collision severity exceeding the third threshold in step S55 might indicate towards a black swan event. The assistance system may determine to filter out, in particular to disregard from further consideration the third predicted behavior due to both the determined value for the situation probability 13 and the determined value for the collision probability 14 being low, e.g. smaller than the respective first and second thresholds.

FIG. 8 provides a flowchart illustrating a processing flow for processing different behavior options and detected black swan events and planning with two planning modules.

The process for behavior planning integrating a handling of detected black swan events starts in step S7 with sensing the environment of the ego-agent 1 and generating a sensor signal based on the sensed environment. The sensor signal includes a current representation of the environment of the ego-agent 1. In the environment of the ego-agent 1, at least one other agent is present.

The method proceeds with step S8 of predicting behavior alternatives for the at least one other agent 2 present in the environment of the ego-agent 1.

In step S8, the method plans, by a first planning module, a first behavior of the ego-agent 1 based on the environment representation and the predicted possible behaviors (behavior alternatives) of the at least one other agent 2.

The first planning module generates control signals in step S10. The generated control signals base on the planned first behavior. The first planning module provides the generated control signals to a control module for controlling at least one actuator for controlling the ego-agent 1 to perform the planned first behavior.

In step S11, the method performs a detection process for detecting black swan events in the sensed environment of step S7. Detecting black swan events may base on the process steps S1 to S6 of FIGS. 1 and 2. However, it is noted that another method providing one or even a plurality of black swan events with an associated situation probability of the black swan event may be employed in step S11.

In step S12 following step S11, the method plans a second behavior based on the detected black swan event. In particular, a second planning module plans the second behavior of the ego-agent 1 based on the environment representation and the predicted possible behaviors of the at least one other agent 2 under the assumption that the detected black swan events occurs.

In step S13, the method monitors the evolvement of the environment based on the sensor signal, in particular based on the environment representation and the situation probability of the at least one detected black swan event.

If in step S13, the method determines that the actual situation probability of the at least one black swan event exceeds a detection threshold, the method proceeds to step S14. In step S14, the method switches to executing the planned second behavior, which was planned in step S12 by the second planning module. The second planning module generates control signals in step S14, the generated control signals base on the planned second behavior and provides the generated control signals to a control module for controlling at least one actuator for controlling the ego-agent 1 to perform the planned second behavior.

FIG. 9 bases on the schematic example of values for the situation probability 13, collision probability 14 and collision severity 15 for normal events and for black swan events in the example of the road traffic scenario of FIGS. 6 and 7.

As discussed with reference to FIGS. 7 and 8, the assistance system includes an implementation of the method for detecting black swan events according to FIGS. 1 and 2. In accordance with the processing of FIG. 8, the assistance system performs the planning process for planning the behavior of the ego-agent 1 in a planning module 16 including two distinct planners.

The planning module 16 comprises a first planner 16.1, which is a long-term planner. The long-term planner uses a complex risk model and plans for a first planning horizon. The first planner 16.2 performs proactive planning for determining a planned behavior of the ego-agent 1 for behaviors of the other agent 2 that have a high probability of occurrence, e.g. a high situation probability. The first planning horizon is longer than a second planning horizon. In a particular implementation, the second planning horizon extends for 12 seconds into the future.

The first planner 16.1 performs behavior planning for situations that include the first predicted behavior with the predicted trajectory 4.1 in FIG. 7, for example. The planning module 16 provides the planned behavior of the first planner 16.1 via a planning selector 19 to an actuation controller of the assistance system 1 as a default in case no black swan event is detected and the situation probability of any black swan event is smaller than a predetermined detection threshold.

The first planner 16.1 is specifically adapted to implement a driving strategy that emphasizes long-term proactive actions for execution of the ego-agent 1. Considering the example of road traffic and the ego-agent 1 being a traffic participant, e.g. an ego-vehicle, the first planner is adapted to prefer a comfortable, forward-looking action anticipating the predicted evolvement of the current traffic situation. Nevertheless, a prediction of the evolvement of the situation proves wrong more often and the planned behavior may change more often in consequence.

The planning module 16 comprises a second planner 16.2, which is a short-term planner. The short-term planner uses a simple risk model and plans for the second planning horizon. The second planning horizon is shorter than the first planning horizon. For example, the second planning horizon may extend to only a fraction of the first planning horizon into the future. In a particular implementation, the second planning horizon extends for 4 seconds into the future.

The second planner 16.2 performs behavior planning for situations that include the second predicted behavior with the predicted trajectory 4.2 in FIG. 7, for example, which has been associated with a black swan event. The planning module 16 provides the planned behavior of the second planner 16.2 via a planning selector 19 to an actuation controller of the assistance system 1 in case the black swan event is detected and an actual situation probability of the detected black swan event exceeds the predetermined detection threshold. In particular, in case the actually determined situation probability of the detected black swan event is increasing and exceeds the predetermined detection threshold.

The second planner 16.2 is specifically adapted to implement a driving strategy that emphasizes short-term reactive actions for execution by the ego-agent 1. Considering the example of road traffic and the ego-agent 1 being a traffic participant, e.g. an ego-vehicle, the second planner is adapted to prefer utility-focused and decisive driving actions that may include strong braking actions and sharp direction changes actions but will require only reduced computational cost due to the short planning horizon and simple risk model employed for planning. The second planner 16.2 will not always be able to plan a behavior and actions of the ego-agent that are proactive due to its limitations with regard to its short planning horizon, its fast reaction time, and the simple risk model used for planning.

The planning module 16 of FIG. 9 includes a planning select controller 17, which monitors the current situation in the environment of the ego-agent 1 based on an obtained environment representation and detected black swan events. The planning select controller 17 provides a planning select signal 18 to control the planning selector 19 to provide the planned behavior of the first planner 16.1 to the actuation controller of the assistance system 1 in case no black swan event is detected and the situation probability of any black swan event is smaller than the predetermined detection threshold. The planning select controller 18 provides the planning select signal 18 to control the planning selector 19 to provide the planned behavior of the second planner 16.2 to the actuation controller in case the black swan event is detected and the actual situation probability of the detected black swan event exceeds the predetermined detection threshold.

Thus, the planning module 16 receives input on detected intentions of the other agent 2 that are unlikely, e.g. the situation probability of the predicted behavior of the other agent 2 associated with the detected unlikely intention is low, but have a significant collision probability and a significant collision severity. The planning module 16 considers the predicted behavior, e.g. the second behavior 4.2, associated with the detected black swan event, in a second short-term planer 16.2. The planning module reacts immediately on determining that the predicted behavior associated with the black swan event is about to occur by basing the planned behavior on the planned behavior of the second, short-term planner in reaction to the unlikely, but potentially severe black swan event is about to occur.

Using parallel first and second planners 16.1, 16.2 with respectively optimized planning strategies in combination with the switching capability for switching between the first and second planners 16.1, 16.2 enables to switch between strategies depending on the detected type of situation in the environment, and to enable the ego-agent to act appropriately, in particular to the detected black swan event by switching to a short-term-oriented, decisive planned behavior for execution.

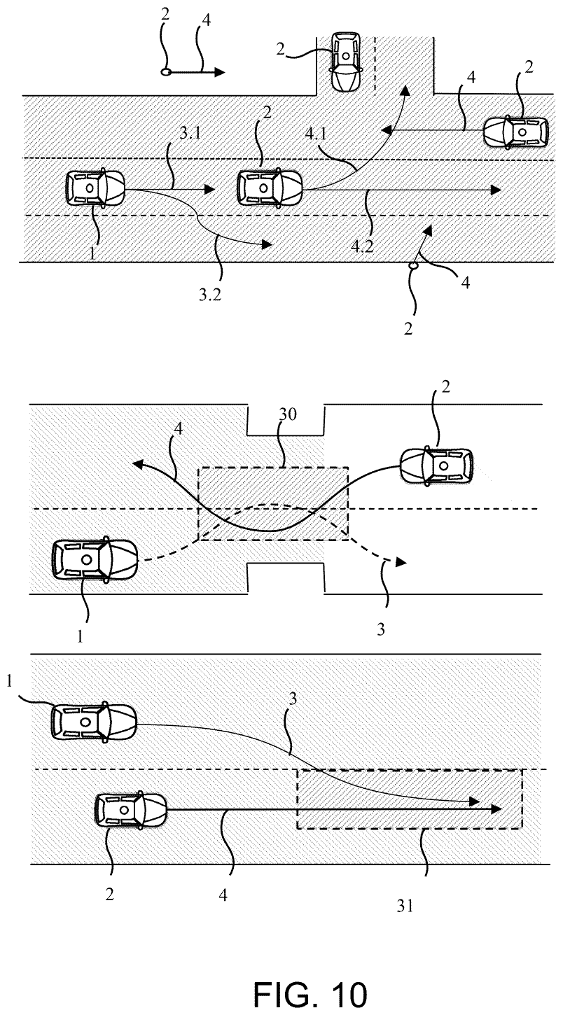

FIG. 10 illustrates complex exemplary traffic situations including plural agents in an urban environment.

The top illustration of FIG. 10 illustrates a complex exemplary traffic situation at an intersection including an ego-agent 1 and plural other agents 2, which is characteristic for an urban traffic environment.

The complex traffic situation depicted in the top portion of FIG. 10 illustrates the resulting complexity of the objective of deciding on a proper maneuver sequence for the ego-agent 1. The planning of a proper maneuver sequence for the behavior the ego-agent 1 includes selecting a particular behavior for execution by the ego-agent 1 out of a plurality of behavior candidates, which each result in a respective trajectory 4, 5 (ego-trajectory) of the ego-agent 1 when executed.

The traffic situation includes various sources of risk, e.g., collision risks and curvature risks. The potential ego-trajectory 4 has to take both a collision risk with the other agent 2 in the lower right of the figure and a curvature risk due to the lane change from the lane on which the ego-vehicle 1 is currently driving to the right lane into account. Moreover, there exist plural behavior alternatives for the other agent 2 immediately front of the ego-agent 1 on the same lane. A plurality of behavior alternatives results in plural planned trajectories 3.1, 3.2 for the ego-agent 1, which each result in different potential outcomes and different risks associated with each planned trajectory 4, 5.

Furthermore, the depicted traffic situation covers a plurality of regulatory items, e.g. the right of way at the intersection of two roads, which includes apparently no traffic lights or signs. Thus, the regulatory items including traffic lights, road signs, and the applicable traffic rules all heavily influence the traffic situation to be assessed and need to be resolved by the assistance system. This applies in particular to the dense urban traffic environment that typically includes a plurality of agents, a variety of regulatory items and a plurality of risk sources as relevant elements at the same time. Further challenges in planning a behavior for the ego-agent 1 exist due to the evolvement of the traffic situation, which is particularly rapid in the urban environment, contrary to the slower scene evolvement encountered on overland routes, for example. The evolvement of the traffic situation requires a constant update of situation-aware planning and benefits in particular from the advantages available by detecting black swan events inherent to the highly dynamic traffic scenario of the upper portion of FIG. 10.

The complex traffic scenario of FIG. 10 may even be further complicated in urban environments, which may include obstacles that occlude parts of the environment of the ego-agent 1 to sensors mounted on the ego-agent and thereby restricting the field-of-view of the sensors. U.S. Pat. No. 10,627,812 B2 proposes to include virtual other agents 2 (traffic entities) in the areas for which the assistance system has unreliable or no perception of the situation at all, predicting at least one behavior of the virtual other agents 2 that may influence the planned behavior of the ego-agent 1. A risk measure for each combination of the at least one predicted behavior of the virtual other agent 2 and the predicted behavior of the ego-agent 1 is estimated and evaluated, and a controlling action for the ego-agent 1 is then based on the evaluated risk measure. The approach of U.S. Pat. No. 10,627,812 B2 may be combined with the proposed processes for detecting and handling of black swan events, which may include predicted behaviors by virtual other agents 2.

The mid portion and the lower portion of FIG. 10 illustrate two further exemplary traffic situations including plural agents.

While the top portion of FIG. 10 shows a traffic situation, which illustrates the objective of finding a behavior for the ego-agent 1 to cope with the scenario posed by a complex traffic situation, the traffic situations of the mid portion and the lower portion of FIG. 10 show the challenge posed by ordering problems. The mid portion and the lower portion of FIG. 10 show respective road traffic scenarios, in which the predicted behaviors of the ego-agent 1 and the other agent 2 result in a respective planned trajectory 3 for the ego-agent 1 and predicted trajectory 4 for the other agent 2, which result in a behavior that has a significant collision risk in an area 30, 31 in the environment.

In the case of the center portion of FIG. 10, monitoring a black swan event resulting from a misjudgment of the other vehicle's intention by the ego-agent 1 may prove advantageous. Black swan monitoring can especially help because traffic rules fail in unambiguously supporting a solution to the ordering problem inherent in the depicted traffic situation, and a potential head-on situation, and because a head-on collision with significant impact energy due to high difference velocity of the vehicles may result in severe consequences in case of a collision. Moreover, if the ego-agent 1 and the other vehicle 2 enter the narrow area 30, a collision between the ego-agent 1 and the other agent may have a high collision probability due to the restricted road width in the area 30.

A similar case is the scenario in the lower portion of FIG. 10, monitoring a black swan event resulting from a misjudgment of the other vehicle's intention by the ego-agent 1 may prove advantageous. A potential collision with significant impact energy due to high velocities of the ego-agent 1 and the other agent 2 may result in a significant collision severity in case of a collision. Moreover, if the ego-agent 1 and the other vehicle 2 both move into the area 31 simultaneously, a collision between the ego-agent 1 and the other agent may have a high collision probability due to the single lane in the area 30 having not enough room for two vehicles.

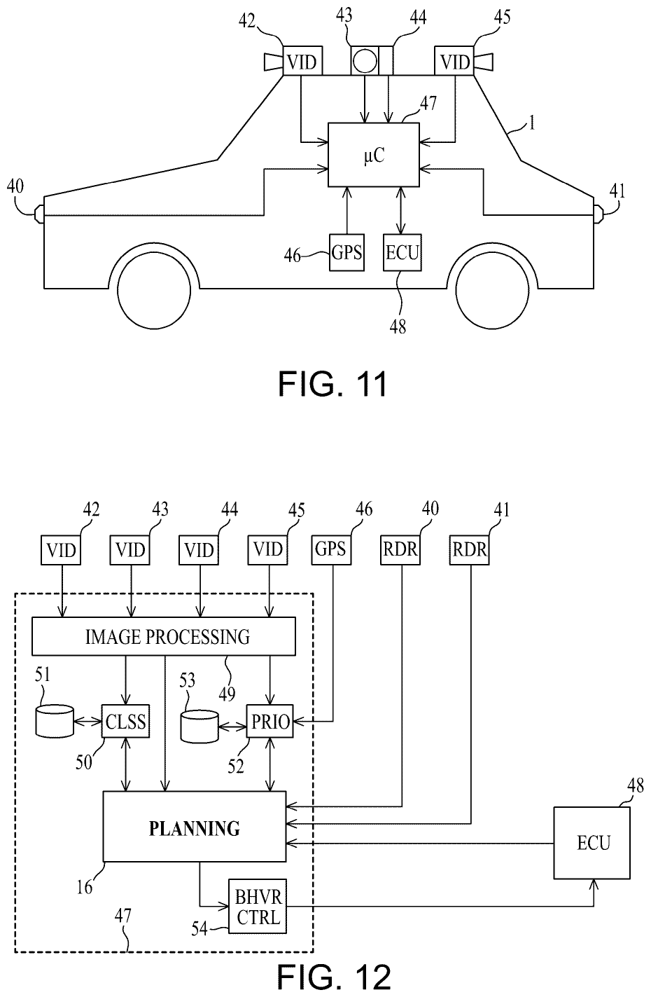

FIG. 11 provides an overview over a vehicle representing an ego-agent 1 configured for applying the method according to an embodiment. The ego-agent 1 of FIG. 11 corresponds in its features to the ego-vehicle as disclosed in US 2020/231149 A1.

In particular, FIG. 11 illustrates a road vehicle (ego-vehicle) as one particular embodiment of the ego-agent 1 in a side view. The ego-vehicle is equipped with the system for assisting a person as a driver in operating the ego-vehicle 1. The assistance system may provide assistance by outputting information, e.g. warning signals or recommendations on actions, to the assisted person in situations with respect to other agents, e.g. other traffic participants, and in the form of an autonomous or at least partially autonomous system may provide assistance by operating the ego-agent 1.

The ego-agent 1 may be any type of road vehicle including, but not limited to, cars, trucks, motorcycles, busses, and reacts to other agents 2 as other traffic participants, including but not limited to, pedestrians, bicycles, motorcycles, and automobiles.

The ego-agent 1 shown in FIG. 11 includes a plurality of sensors, including a front RADAR sensor 40, a rear RADAR sensor 41 and plural camera sensors 42, 43, 44, 45 for sensing the environment around the ego-agent 1. The plurality of sensors is mounted on a front surface of the ego-agent 1, a rear surface of the ego-agent 1, and the roof of the ego-agent 1, respectively. The camera sensors 42, . . . , 45 preferably are positioned so that a 360° surveillance area around the ego-agent 1 is possible. Thus, the ego-agent 1 is capable of monitoring the environment of the ego-agent 1.

Alternatively or in addition, further sensor systems, e.g. a stereo camera system or a LIDAR sensor may be arranged on the ego-agent 1.

The ego-agent 1 further comprises a position sensor 46, e.g., a global navigation satellite system (GNSS) navigation unit, mounted on the ego-agent 1 that provides at least position data that includes a location of the ego-agent 1. The position sensor 46 may further provide orientation data that includes a spatial orientation of the ego-agent 1.

The plurality of sensors 40, 41,42, 43, 44, 45, 46 may at least in part be pooled as a sensor system that senses the environment of the ego-agent and generates a sensor signal based on the sensed environment or further evaluation.

The driver assistance system of the ego-agent 1 further comprises at least one electronic control unit (ECU) 48 and a computer 47. The computer 47 may include at least one processor, e.g. a plurality of processors, microcontrollers, signal processors and peripheral equipment for the processors including memory and bus systems. The computer 47 receives or acquires the signals from the front RADAR sensor 40, the rear RADAR sensor 41, the camera sensors 42, . . . , 45, the position sensor 46, and status data of the ego-agent 1 provided by the at least one ECU 48. The status data may include data on a vehicle velocity, a steering angle, an engine torque, an engine rotational speed, or a brake actuation for the ego-agent 1.

FIG. 12 shows a schematic structural diagram illustrating functional elements of the computer 9 of a driver assistance system according to an embodiment. The functional description of the computer 47 of the ego-agent 1 of FIG. 12 corresponds in its features to the ego-vehicle as disclosed in US 2020/231149 A1.

An already existing computer 47 includes, as a processing unit, at least one processor or signal-processor used for processing signals of an assistance system of the ego-agent 1, e.g. an adaptive cruise control. The computer 47 may be configured to implement the functional components described and discussed below. The depicted computer 47 comprises an image processing module 49, an object classification module 50, an object database 51, a priority determination module 52, a map database 53, a planning module 16, and a behavior determination module 54. The computer 47 may implement or comprise a prediction module not specifically illustrated in the figures, which is specifically adapted to predict a behavior of another agent 2 based on an environment representation generated based on a sensor signal, a plurality of sensor signals, or in particular preprocessed sensor signals.

Each of the modules is implemented in software that is running on the at least one processor or at least partially in dedicated hardware including electronic circuits.

The image processing module 49 receives the signals from the camera sensors 42, . . . , 45 and identifies relevant elements in the environment including but not restricted to a lane of the ego-vehicle (ego lane), objects including other agents in the environment of the ego-vehicle, a course of the road, and traffic signs in the environment of the ego-vehicle.

The classification module 50 classifies the identified relevant elements and transmits a classification result to the planning module 16, wherein at least the technically feasible maximum velocity and acceleration of another agent 2 identified by the image-processing module 49 and assessed as relevant by the planning module 16 are determined based on the object database 51.

The object database 51 stores a maximum velocity (speed) and an acceleration for each of a plurality of vehicle classes, e.g. trucks, cars, motorcycles, bicycles, pedestrians, and/or stores identification information (type, brand, model, etc.) of a plurality of existing vehicles in combination with corresponding maximum velocity and acceleration.

The priority determination module 53 individually determines a priority relationship between the ego-vehicle and each other agent 2 (traffic participant) identified by the image-processing module 49 and involved in the current traffic situation under evaluation by the planning module 16. The traffic situations may be classified into at least two categories by the priority determination module 52:

In a longitudinal case, the ego-agent 1 and the other agent 2 move on the same path or lane and in a same direction, e.g., one vehicle follows the other one. In a lateral case, at the current point in time, the ego-agent 1 and the other agent 2 do not move on a same path, but the paths of the ego-agent 1 and the other agent 2 intersect or merge within a prediction horizon of the assistance system. Thus, currently the moving directions of the ego-agent 1 and the respective other agents 2 are different. Exemplary scenarios in the road traffic environment could be road intersections, merging lanes, and more.

In a lateral case, the priority determination module 52 determines whether the ego-agent 1 has right of way over the other agent 2, or the other agent 2 has the right of way over the ego-agent 1 based on the lane, a location of the other agent 2, the course of the road, and/or the traffic signs identified by the image processing module 49. Alternatively or in addition, the priority determination module 52 performs the determination based on a position signal of the position sensor 46 and map data from the map database 53 that includes information on applicable priority rules for the road network.

The planning module 16 calculates at least one hypothetical future trajectory for the ego-agent 1 based on the status data received from the ECU 48, the information received from the image-processing module 49, the signals received from the front RADAR sensor 40 and the rear RADAR sensor 41, and, in case of the ego-agent 1 autonomously driving, information on the driving route that is defined by driving task. The calculated trajectory, e.g. the planned trajectory 4, 5 of the ego-agent 1 indicates a sequence of future positions of the ego-agent 1.

According to the present invention, the planning module 16 selects a prediction model for the other traffic participant depending on the priority relationship determined by the priority determination module 52. Further, the maximum velocity and acceleration may be determined by the classification module 50, wherein, when the ego-vehicle 1 and the other agent 2 follow the same path, the selected prediction model may define a constant velocity over the prediction horizon. This means that for a prediction performed based on a current situation, the other agent 2 is assumed to move further with a constant velocity for a time interval corresponding to the prediction horizon.

On the other hand, when the trajectory of the ego-agent 1 and the trajectory of the other agent 2 intersect or merge, a prediction model that defines a delayed change of velocity is selected. In particular, a delayed decrease of velocity as the delayed change of velocity is set, if the ego-agent 1 has right of way over the other agent 2. A delayed increased of velocity as the delayed change of velocity is defined in the prediction model that is selected if the other agent 2 has right of way over the ego-agent 1.

In order to determine a suitable or best behavior for the ego-agent 1, the planning module 16 may calculate a plurality of trajectories for the ego-agent 1 (ego-trajectories) and select the ego-trajectory, which results in the best behavior relevant score, as disclosed in U.S. Pat. No. 9,463,797 B2, or iteratively change at least one of the ego-trajectory velocity profile to optimize the behavior relevant score.

The planning module 16 may perform planning of the behavior of the ego-agent 1 based on the improved processes that computationally predict future states of objects in a traffic environment, the objects including other agents 2, as disclosed in U.S. Pat. No. 9,878,710 B2 for example.

The planning module 16 outputs information on the finally determined ego-trajectory (velocity profile) to the behavior determination module 54. The behavior determination module 54 determines a behavior of the ego-vehicle 1 based on the information provided by the planning module 16, generates corresponding driving control signals for executing the determined behavior by controlling at least one of acceleration, deceleration, and steering of the ego-agent 1, and outputs the generated control signals to the ECU 48.

Alternatively or in addition, the behavior determination module 54 may generate and output at least one of warning signals or information recommending actions for a person operating the ego-agent 1. The ego-agent 1 may include suitable output means including, for example, loudspeakers for an acoustic output, a display screen or a head-up-display for a visual output to the operator of the ego-agent 1.

The assistance system executes the described processes and steps repeatedly and parameters of the selected prediction model are adapted to changes in the environment and to behavior changes of the ego-agent 1 and the other agent 2.

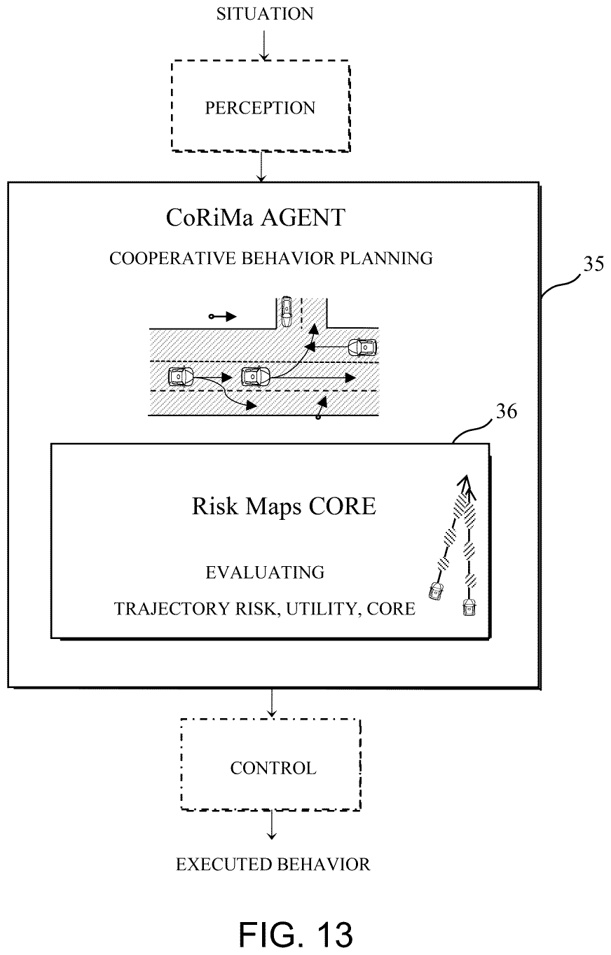

FIG. 13 illustrates a simplified processing flow for planning a complex behavior of the ego-agent 1 to cope with a complex situation in the environment.

The simplified processing flow illustrates in particular the processing for planning a behavior that uses a representation of the perceived situation in the environment of the ego-agent 1 as an input to a cooperative behavior-planning module 35 (CoRiMa agent). The cooperative behavior-planning module 35 performs behavior planning based on a representation of the perceived environment including the ego-agent 1 and the at least one other agent 2. In particular, the cooperative behavior-planning module 35 is a computer-implemented system that generates appropriate behavior options for the ego-agent 1 to address the perceived situation for further evaluation. The cooperative behavior-planning module 35 generates appropriate trajectories for a comprehensive environment representation. The cooperative behavior-planning module 35 provides generalizable concepts for an efficient analysis. The cooperative behavior-planning module 35 performs a selection from the behavior options and the predicted trajectories and planned trajectories.

For evaluating trajectories, the cooperative behavior-planning module 35 may rely on a risk-mapping module 36 (risk maps core). The risk-mapping module 36 assigns a value to trajectories input based on an evaluation of at least one of a trajectory risk, e.g. a collision risk, a utility of the trajectory, and a comfort of the trajectory when performed. The risk-mapping module 36 thereby provides an evaluation of a behavior corresponding to the evaluated trajectory. The proposed behavior-planning module 35 and the risk-mapping module 36 may be integrated into an analytic, interpretable, generalizable and holistic approach of analyzing the behavior alternatives and predicted trajectories benefitting from proven advantages of a risk analysis based on risk maps over existing other evaluation methods for trajectories and for behavior planning.

The cooperative behavior-planning module 35 and the risk-mapping module 36 may form part of an implementation of the planning module 16 and the behavior determination module 54 of the computer 47 of the ego-agent 1 from FIG. 12.

The cooperative behavior-planning module 35 determines a selected behavior and an appropriate trajectory 3 for the ego-agent 1 in the current situation. The behavior determination module 54 may generate corresponding driving control signals for executing the determined behavior by controlling at least one of acceleration, deceleration, and steering of the ego-agent 1, and outputs the generated control signals to the ECU 48 of the ego-agent 1 from FIG. 12 in order to execute the determined behavior.

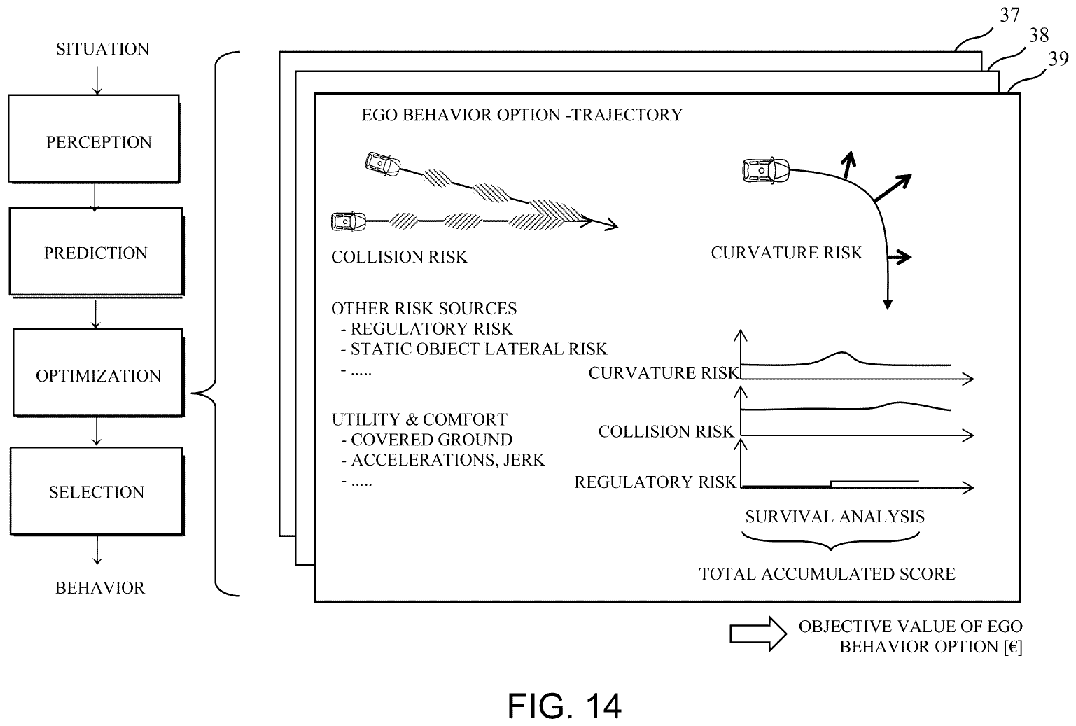

FIG. 14 illustrates an example of a plurality of behavior options for the ego-agent 1 in a behavior planning system based on an implementation of the cooperative behavior-planning module 35 and the risk-mapping module 36 according to FIG. 11.

Perceiving the environment to generate the representation and predicting behavior alternatives for the current situation in the environment of the ego-vehicle 1 provides a plurality of behavior options 37, 38, 39 (ego-behavior options) for evaluation in the risk-mapping module 36.

Each behavior option 37, 38, 39 corresponds to a trajectory of the ego-agent 1, which is analyzed with respect to an associated risk including a plurality of specific risk types of which some are discussed in more detail.

Analyzing the collision risk of the ego-agent 1 with one other agent 2 of plural other agents 2 may include computing a collision probability that is proportional to a product of two Gaussian distributions and a modelled severity of the collision between the ego-agent 1 and the other agent 2 involved in the collision.

Other types of risks taken into account may include regulatory risk, e.g. speed limits, or a static object lateral risk.

Further aspects of each behavior option 37, 38, 39, which may be taken into account include at least one of a utility and the comfort of the behavior option 37, 38, 39. The utility of the behavior option 37, 38, 39 may be determined by assessing a covered ground by the ego-agent 1 while moving along the trajectory of the behavior option 37, 38, 39. The comfort of the behavior option 37, 38, 39 may be computed based on an acceleration, which is exerted on the ego-agent 1 while moving along the trajectory of the behavior option 37, 38, 39. Alternatively or additionally, the comfort of the behavior option 37, 38, 39 may be computed based on a jerk, which is exerted on the ego-agent 1 while moving along the respective trajectory 3 of the behavior option 37, 38, 39.

Based on the analysis, the risk-mapping module 36 assigns an objective value to each ego-behavior option 37, 38, 39. The objective value may be determined based on a total accumulated score computed based on a survival analysis. FIG. 14 illustrates three exemplary types of risks contributing to the total accumulated score, the curvature risk, the collision risk, and the regulatory risk.

The ego-behavior options 37, 38, 39 are optimized based on a cost function corresponding to the objective value of each ego-behavior option 37, 38, 39.

The optimized ego-behavior options 37, 38, 39 are provided to a subsequent selecting step, which selects the most suitable optimized ego-behavior options 37, 38, 39. The selection may be a conditional selection, e.g. the selected ego-behavior options 37, 38, 39 are selected under the prerequisite that a predetermined event in the perceived situation is determined to occur. In case of the conditional selection, a most suitable optimized ego-behavior may be selected from the optimized ego-behavior options 37, 38, 39.

Finally the selected ego-behavior 37, 38, 39 is output for the ECU 48 for execution by the ego-agent 1 to the ECU 48.

What is claimed is:

1. A computer-implemented method for assisting operation of the ego-agent, comprising
sensing an environment of the ego-agent that includes at least one other agent;
predicting behaviors of the at least one other agent based on the sensed environment;
planning, by a first planning module, at least one first behavior of the ego-agent based on the predicted behaviors of the at least one other agent;
generating a control signal for at least one actuator for assisting operation of the ego-agent based on the planned at least one first behavior;
detecting at least one black-swan event in the environment of the ego-agent based on the predicted behaviors of the at least one other agent;
planning, by a second planning module different from the first planning module, a second behavior of the ego-agent based on the predicted behaviors of the at least one other agent and the detected at least one black-swan event in the environment of the ego-agent;
monitoring based on the sensed environment whether a computed situation probability of the detected black-swan event exceeds a detection threshold; and
in case the computed situation probability of the detected at least one black-swan event exceeds the detection threshold, generating the control signal for the at least one actuator for assisting operation of the ego-agent based on the planned second behavior.

2. The computer-implemented method for assisting operation of the ego-agent according to claim 1, wherein
the second planning module runs in parallel to the first planning module.

3. The computer-implemented method for assisting operation of the ego-agent according to claim 1, wherein
the second planning module uses a second risk model less complex than a first risk model used by the first planning module.

4. The computer-implemented method for assisting operation of the ego-agent according to claim 1, wherein
the second planning module uses a time-to-closest encounter risk model without uncertainty consideration.

5. The computer-implemented method for assisting operation of the ego-agent according to claim 1, wherein
the first planning module uses a survival analysis risk model including uncertainty consideration.

6. The computer-implemented method for assisting operation of the ego-agent according to claim 1, wherein
a second planning horizon of the second planning module is shorter than a first planning horizon of the first planning module, or
the second planning horizon of the second planning module extends a fraction of the first planning horizon of the first planning module into the future, or
the second planning horizon of the second planning module extends up to 4 seconds and the first planning horizon of the first planning module extends up to 12 seconds into the future.

7. The computer-implemented method for assisting operation of the ego-agent according to claim 1, wherein
planning, by the second planning module, the second behavior of the ego-vehicle including at least one of a deceleration and a steering angle change that exceed a corresponding deceleration or steering angle change of the at least one first behavior planned by the first planning module.

8. The computer-implemented method for assisting operation of the ego-agent according to claim 1, wherein
the second planning module uses a short-term planning algorithm running at a higher frequency than a long-term planning algorithm used by the first planning module.

9. The computer-implemented method for assisting operation of the ego-agent according to claim 1, wherein the method comprises
assigning additional processing resources to a prediction module for predicting the behaviors of the at least one other agent based on the sensed environment in case the computed situation probability of the detected black-swan event exceeds the detection threshold.

10. The computer-implemented method for assisting operation of the ego-agent according to claim 1, wherein the method comprises
the second planning module uses a second planning strategy different from a first planning strategy used by the first planning module, or
the second planning module uses the second planning strategy different from the first planning strategy wherein the second planning strategy has a smaller cruising velocity for the ego-agent compared to the first planning strategy.

11. The computer-implemented method for assisting operation of the ego-agent according to claim 1, wherein
the second planning module uses, for each predicted situation that includes predicted behaviors for plural other agents, one other agent with a predicted unlikely behavior and a most likely behavior for all other agents different from the one other agent.

12. The computer-implemented method for assisting operation of the ego-agent according to claim 1, wherein the method comprises
detecting plural black swan events in the environment of the ego-agent,
monitoring based on the sensed environment whether each computed situation probabilities of the detected plural black-swan events exceeds a corresponding detection threshold; and
in case the computed situation probabilities of the detected plural black-swan events exceed the corresponding detection threshold for the detected plural black-swan events, switching to a planned second behavior of a black swan event of the plural black swan events, which is predicted to occur closest to a current time.

13. The computer-implemented method for assisting operation of the ego-agent according to claim 1, wherein the method comprises
while generating the control signal based on the planned second behavior,
monitoring based on the sensed environment whether the computed situation probability of the detected black-swan event falls below a detection threshold, and
switching to generating the control signals for the at least one actuator based on the planned at least one first behavior in case the computed situation probability of the detected potential black-swan event falls below the detection threshold.

14. The computer-implemented method for assisting operation of the ego-agent according to claim 1, wherein
operating the ego-agent includes autonomously operating the ego-agent or assisting a human driver in operating the ego-agent, and
the ego-agent includes at least one of a land vehicle, a watercraft, an air vehicle and a space vehicle.

15. The computer-implemented method for assisting operation of the ego-agent according to claim 1, wherein detecting the black-swan event comprises
computing for each predicted behavior of the at least one other agent the situation probability and a collision probability of a collision with the ego-agent;
determining, for each predicted behavior, a collision severity of the collision with the ego-agent;
detecting the potential black swan event in the environment of the ego-agent for each predicted behavior of the at least one other agent for which the computed situation probability is smaller than a first threshold, and the computed collision probability exceeds a second threshold, and the determined collision severity exceeds a third threshold.

16. The computer-implemented method for assisting operation of the ego-agent according to claim 15, wherein the method comprises
monitoring the computed situation probability of the at least one detected black-swan event, and
in case the computed situation probability of the detected black-swan event exceeds a detection threshold, changing a planning strategy for operating the ego-agent in the behavior planning system according to a different planning strategy.

17. The computer-implemented method for assisting operation of the ego-agent according to claim 16, wherein
applying the different planning strategy for operating the ego-agent includes decreasing a preset velocity of the ego-agent.

18. The computer-implemented method for assisting operation of the ego-agent according to claim 15, wherein the method comprises
filtering out predicted behaviors of the at least one other agent from further consideration in the assistance system that have the computed situation probability smaller a fourth threshold and the computed collision probability below a fifth threshold.

19. An advanced driver assistance system comprising a processing unit configured to execute the method according to claim 1.

20. A vehicle comprising the advance driver assistance system according to claim 19.
